(19) United States
(12) Patent Application Publication
(10) Pub. No.: US 2015/0298610 A1
(43) Pub. Date: Oct. 22, 2015

(54) VEHICLE MOUNTED HEAT EMITTING LIFE FORM DETECTOR

(71) Applicant: Paul Wilk, JR., Orchard Park, NY (US)

(72) Inventor: Paul Wilk, JR., Orchard Park, NY (US)

(21) Appl. No.: 14/257,028

(22) Filed: Apr. 21, 2014

(51) Int. Cl. B60Q 9/00; G01J 5/00; G01J 5/18; G02B 27/01

(52) U.S. Cl. CPC B60Q 9/008; G02B 27/0101; G01J 5/0025; G01J 5/18; B60R 2300/205; G02B 2027/014

(57) ABSTRACT

A heat emitting life form detector comprises an elongated rectangular base having two thermal detectors, a controller, an a heads-up display module, an audible alarm module, a power module. The controller, comprising a processor and memory, is connected to the components of the heat emitting life form detector and receive inputs therefrom or provide outputs thereto. The thermal detectors are connected to the controller, enabling them to be provided with electrical power from the power module and to provide electrical signal outputs relating to remote temperature measurements thereto. The processor additionally classifies objects detected by the thermal detectors as life forms or not based on the outputs of the thermal detectors. The combined outputs are provided to the heads-up display for providing a visual representation of any life forms detected. In addition, the audible alarm is sounded whenever life forms are detected in the path of the host vehicle.

### BACKGROUND OF THE INVENTION

1. Field of the Invention

This invention relates generally to automotive accessories and, more particularly, to a heat emitting life form detector for mounting in a vehicle to prevent collisions with humans and animals.

2. Description of the Prior Art

For many motorists, driving at night can be dangerous to not only the occupants of the motorist's vehicle, but for those in the immediate vicinity or path of said vehicle. The use of headlights and even high beam headlights is to improve visibility at night is well known. A problem which still exists with headlights, however, is they commonly only extend visibility a few feet or tens of feet; which is typically not enough to avoid collisions in a moving vehicle by the time a human or animal becomes visible in such a circumstance. Thus, there remains a need for a heat emitting life form detector which enable a motorist to see representations of and avoid collisions with life forms in his path. It would be helpful if such a heat emitting life form detector employed a heads-up display and audible alarm to visibly alert a motorist of the presence of a life form without requiring the motorist to look away from the road. It would be additionally desirable for such a heat emitting life form detector to be sized to be mounted inside a vehicle cabin and powered by electricity from the vehicle.

The Applicant's invention described herein provides for a life form detector adapted to improve the visibility of heat emitting life forms for motorists. The primary components in Applicant's heat emitting life form detector are a thermal sensor, a controller, a heads-up display module, and a audible alarm. When in operation, the heat emitting life form detector enables heat emitting life forms in the path of a vehicle to be detected and projected on a heads-up display. As a result, many of the limitations imposed by prior art structures are removed.

### SUMMARY OF THE INVENTION

A heat emitting life form detector for enabling a motorist to identify and avoid collisions with life forms in the path of his vehicle. The heat emitting life form detector comprises an elongated rectangular base having two thermal detectors, a controller, an a heads-up display module, an audible alarm module, a power module. The controller, comprising a processor and memory, is connected to the components of the heat emitting life form detector and receive inputs therefrom or provide outputs thereto. The thermal detectors are connected to the controller, enabling them to be provided with electrical power from the power module and to provide electrical signal outputs relating to remote temperature measurements thereto. The processor additionally classifies objects detected by the thermal detectors as life forms or not based on the outputs of the thermal detectors. The combined outputs are provided to the heads-up display for providing a visual representation of any life forms detected. In addition, the audible alarm is sounded whenever life forms are detected in the path of the host vehicle.

It is an object of this invention to provide a heat emitting life form detector which enable a motorist to see representations of and avoid collisions with life forms in his path.

It is another object of this invention to provide a heat emitting life form detector employing a heads-up display and audible alarm to visibly alert a motorist of the presence of a life form without requiring the motorist to look away from the road.

It is yet another object of this invention to provide a heat emitting life form detector to be sized to be mounted inside a vehicle cabin and powered by electricity from the vehicle.

These and other objects will be apparent to one of skill in the art.

### BRIEF DESCRIPTION OF THE DRAWINGS

FIG. 1 is a top plan view of the interior of a heat emitting life form detector built in accordance with the present invention.

FIG. 1b is a back elevational view of a heat emitting life form detector built in accordance with the present invention

### DETAILED DESCRIPTION OF THE INVENTION

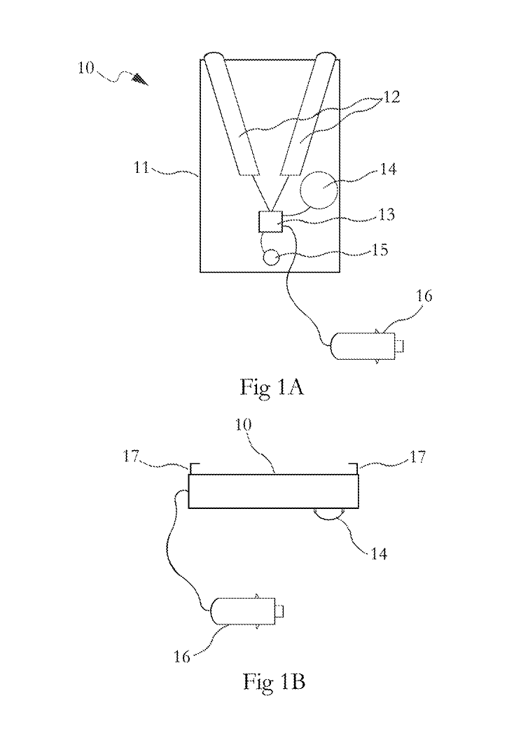

Referring now to the drawings and in particular FIGS. 1a and 1b, a heat emitting life form detector 10 is shown as an elongated rectangular base 11 having two thermal detectors 12, a controller 13, an a heads up display module 14, an audible alarm module 15, a power module 16. Each thermal detector 12 is defined in the preferred embodiment as an infrared sensor employing a thermopile sensor as the infrared sensing element for detecting objects based on remote temperature measurements. The thermal detectors 12 are connected to the controller 13, enabling them to be provided with electrical power from the power module and to provide electrical signal outputs relating to remote temperature measurements thereto.

The controller 13 includes a processing unit and memory and is connected the heads-up display module 14, the audible alarm module 15 and the power module 16 in addition to the thermal detector 12. In this regard, the controller 13 is able to receive electricity from the power module and provide it to heads-up display module 14 and the audible alarm module 15 enabling the operation of the same. In addition to distributing electricity to the components of the heat emitting life form detector 10, the controller 13 processes the outputs of the thermal detectors 12, determines whether the objects detected by the thermal detector 12 are life forms, and causes the audible alarm module 15 to emit an audible alarm when it determines a life form is present in the path of the vehicle in which the heat emitting life form detector 10 is mounted. The determination of whether a heat emitting object sensed by the thermal detector 12 is based on the processor 13 comparing the heat signature of an object as detected from each thermal detector 12 at a plurality of moments and employing a conventional multilateration technique to determine how far the object detect is, whether the object detected is getting closer to the host vehicle and the intensity of the heat signature. For objects moving quickly towards the host vehicle and with a heat signature of low intensity, the processor 13 classifies the object as a life form and signals the audible alarm. Other objects detected are not classified as a life form and no alarm is signaled.

The processor 13 additionally combines the outputs of the thermal detectors 12 into a single output, which is then provided to the heads-up display module 14. The heads-up display module 14 is defined by a conventional video generation computer and a conventional projector unit. The heads-up display module 14 then renders the output from the processor 13 and projects it to a conventional combiner placed on top of the dash board in the host vehicle, substantially in front of the motorist. This enables the combiner to redirect the projected image from the projector unit and provide a fix mounted heads-up display interface based on top of the dashboard of the host vehicle which displays the heat signature of any object detected by the thermal detectors 12 that the processor 13 has classified as a life form.

In the preferred embodiment, the audible alarm module 15 is defined as a speaker and the power module 16 is defined by a 12 volt power supply. The power module 16 is thus able to be powered through a vehicle's cigarette light input. Furthermore, the elongated rectangular base 11 includes a pair of clips 17 which enable it to be hung in the visor area of a vehicle in a similar manner as a conventional radar detector.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A heat emitting life form detector, comprising:
a base housing adapted to be mounted in a host vehicle;
at least one thermal detector integrated with said base housing, wherein said thermal detector is adapted to detect thermal energy in a coverage zone and provide an output relating thereto;
a controller integrated with said base housing and connected to said at least one thermal detector;
an audible alarm module integrated with said base housing and connected to said controller;
a power module connected to said controller, wherein when electrical power is provided to said power module, said controller provides electrical power to said at least one thermal detector and said audible alarm to enable the operation thereof; and
wherein said controller is configured to receive outputs from said at least one thermal detector, determine the presence of a life form in the area monitored by said at least one thermal detector based on said outputs, and cause an audible alarm to emit from said audible alarm module if a life form is present in the area monitored by said at least one thermal detector.

2. The heat emitting life form detector of claim 1, wherein two thermal detectors are integrated with said base housing.

3. The heat emitting life form detector of claim 2, additionally comprising a heads-up display module connected to said processor, wherein said processor is additionally configured to combine the outputs of the two thermal detectors and provide said combined output to said heads-up display module and said heads-up display module enables a representation of any life forms determined to be present in the area monitored by said thermal detectors to be displayed inside the host vehicle.

4. The heat emitting life form detector of claim 1, wherein said power module is a 12 volt power supply.
